(19) United States
(12) Patent Application Publication
(10) Pub. No.: US 2016/0293350 A1
(43) Pub. Date: Oct. 6, 2016

(54) FOOTSWITCH ASSEMBLY

(71) Applicant: HUNTLEIGH TECHNOLOGY LIMITED, Houghton Regis, Bedfordshire (GB)

(72) Inventor: Stephen HOLLYOAK, West Midlands (GB)

(73) Assignee: HUNTLEIGH TECHNOLOGY LIMITED, Houghton Regis Bedfordshire (GB)

(21) Appl. No.: 15/038,368

(22) PCT Filed: Nov. 14, 2014
(86) PCT No.: PCT/GB2014/053376

§ 371 Date: May 20, 2016

(30) Foreign Application Priority Data
Nov. 21, 2013 (GB) 1320567.9

(51) Int. Cl. H01H 3/14; A47C 19/00; H01H 9/20

(52) U.S. Cl. CPC H01H 3/14; H01H 9/20; A47C 19/00

(57) ABSTRACT

A footswitch assembly 10 for controlling an adjustable bed includes a footswitch 14a, 14b for controlling an adjustable bed. The footswitch 14a, 14b has an operative surface 15a, 15b and is configured to be actuated in response to pressure of a foot or part of a foot upon the operative surface 15a, 15b. A guard member 16 is provided which is movable between a guarding position and a non-guarding position. In the guarding position, the guard member 16 is configured to overlie the operative surface 15a, 15b of the footswitch to inhibit actuation of the footswitch 14a, 14b. In the non-guarding position, the guard member 16 is configured to be separated from the operative surface 15a, 15b to allow actuation of the footswitch 14a, 14b. A validation element 24 is configured in response to movement of the guard member into the non-guarding position to validate actuation of the footswitch.

The present invention relates to footswitch assemblies for controlling adjustable beds, such as hospital beds.

Footswitches for the control of bed height adjustment were introduced a number of years ago to allow the carer to adjust bed height without having to touch the bed with their hands. The benefit of this is that they can adjust the bed whilst keeping their hands/gloves sterile.

However, within a year or so of the introduction of footswitches a number of incidents occurred that resulted in patient deaths. Investigations showed that patients had fallen out of bed and in a confused state they had pressed on the footswitches as they tried to lift themselves up from the floor. In some instances this resulted in the bed driving down onto the patient causing crush injuries and in some cases led to death.

Aspects of the present invention seek to provide an improved footswitch assembly.

According to an aspect of the invention, there is provided:
a footswitch assembly for controlling an adjustable bed, including:
a footswitch for controlling an adjustable bed, the footswitch having an operative element and being configured to be actuated in response to pressure of a foot or part of a foot upon the operative element;
a guard member movable between a guarding position and a non-guarding position; wherein in the guarding position the guard member is configured to overlie the operative element to inhibit actuation of the footswitch, and wherein in the non-guarding position the guard member is configured to be separated from the operative element to allow actuation of the footswitch; and
a validation element configured in response to movement of the guard member into the non-guarding position to validate actuation of the footswitch.

That the guard member is configured to overlie the operative element in the guarding position does not imply any particular orientation of the footswitch assembly, but means that the operative element is arranged in the guarding position to obstruct access to the operative element.

Preferred embodiments of the invention are able to provide a footswitch assembly which can control an adjustable bed, but which can prevent inadvertent operation of the adjustable bed which may otherwise cause injury. Embodiments of the invention are able to provide a double effect of inhibiting inadvertent actuation of the footswitch, and, even if inadvertent actuation does occur, ignoring it.

A validated actuation of the footswitch is effective for controlling the bed, and an actuation of the footswitch which is not validated is not effective for controlling the bed. In other words, in order for the bed to be adjusted, actuation of the footswitch must be validated by the validation element. This can mean that even if the footswitch were inadvertently actuated, the lack of validation of the actuation would mean that the bed would still be prevented from being adjusted.

Preferably, the validation element is configured to validate actuation of the footswitch only during a predetermined period of time following a movement of the guard member into the non-guarding position. This provides significant advantages for example if the guard member becomes jammed in the non-guarding position where the footswitch can be inadvertently actuated. The validation element does not validate any actuation of the footswitch which occurs after the predetermined period of time, thereby providing a failsafe system which prevents continued actuation of a potentially jammed assembly.

Preferably the validation element includes a validation element switch which is actuated in response to movement of the guard member into the non-guarding position. This provides a convenient way of validating actuation. In preferred embodiments of the invention, actuation of the footswitch is only validated during a predetermined period of time following actuation of the validation element switch.

Preferably, the guard member is configured to be moveable from the guarding position to the non-guarding position by an extremity of a foot. This can mean that an operator of an adjustable bed, such as a health care worker, can prepare the footswitch assembly for operation without needing to contact any controls with his or her hands, which might otherwise become contaminated, particularly in a hospital setting.

The operative element can be an operative surface of the footswitch.

Preferably, in a guarding position, the guard member is separated from the operative element of the footswitch to allow an extremity of a foot to be inserted between the operative element of the footswitch and the guard member to allow a user to move the guard member to the non-guarding position. However, preferably, there is insufficient space between the guard member and the operative element to allow a foot of a user to be inserted enough to actuate the footswitch. This can mean that, in the guarding position, the footswitch cannot be actuated before the guard member has been moved to the non-guarding position. Preferably, this is achieved by the operative element being an operative surface of the footswitch and the guard member being disposed in the guarding position at an angle with respect to the operative surface, said angle being selected so that there is sufficient space between the operative surface and the guard member for an extremity of a user's foot to move the guard member but insufficient space between the operative surface and the guard member to allow a user's foot to be inserted enough to actuate the foot switch.

In another embodiment, in the guarding position, the guard member can extend beyond an edge of the operative element of the footswitch to allow a foot of a user to contact the guard member in a region laterally adjacent to said edge to allow a user to move the guard member to the non-guarding position. This arrangement means that the foot of the user does not need to be adjacent to the operative element, thereby minimising further the risk of inadvertent actuation of the footswitch.

Preferably, the guard member includes a cover that covers the footswitch in the guarding position, preferably leaving no exposed area of the operative element which might inadvertently receive actuating pressure.

Preferably, the footswitch assembly includes a plurality of footswitches, each of the plurality of footswitches being for causing a different adjustment in the adjustable bed. This can enable a number of controls of the bed, for example “up” and “down” to be protected by the same guard member thereby allowing an operator to make iterative adjustments to the bed without needing to continually move guard members.

In embodiments of the invention, there is provided a footswitch panel including a plurality of footswitch assemblies.

Preferred embodiments of the invention provide the following advantages:
1. The guard member or foot guard prevents inadvertent operation by a patient failing onto the footswitch.
2. The hinged guard has to be lifted to allow access of the operator's foot.
3. The validation element switch or interlock switch is only made when the guard is in its raised position, thereby enabling the foot switch.
4. The interlock switch will only enable the footswitch for a limited period of time thereby limiting the opportunity for unintended operation.

Preferred embodiments of the invention are described below, by way of example only, with reference to the accompanying drawings, in which:

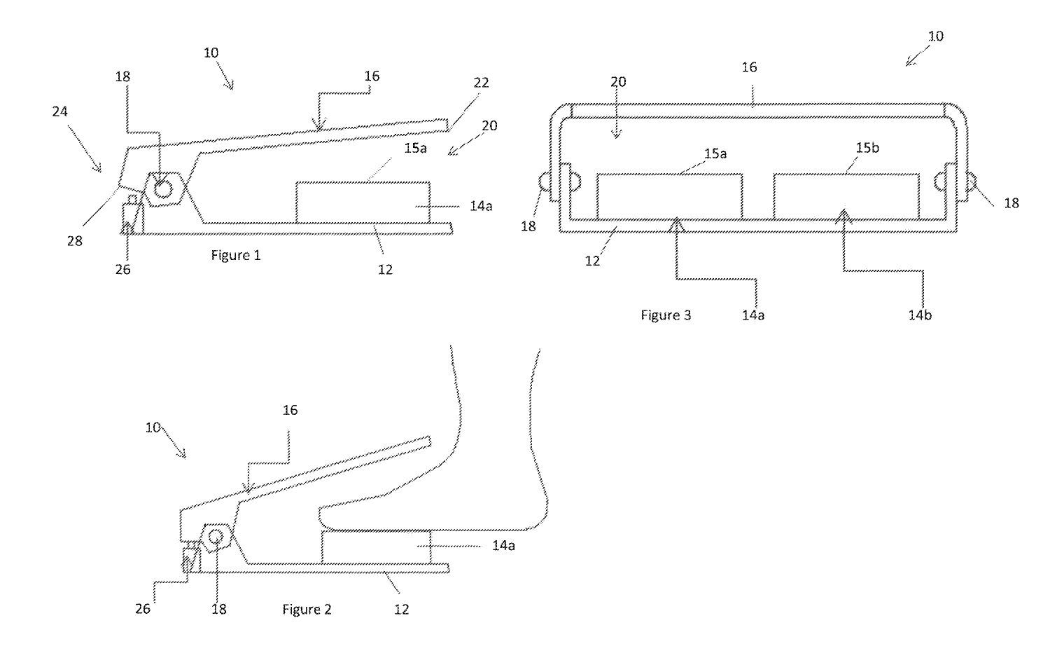

FIG. 1 is a schematic side view of a footswitch assembly according to an embodiment of the invention in a guarding position;

FIG. 2 is a schematic side view of the embodiment of FIG. 1 in a non-guarding position; and

FIG. 3 is a schematic end view of the embodiment of FIGS. 1 and 2.

FIGS. 1-3 show an embodiment of a footswitch assembly 10. The footswitch assembly 10 includes a base 12 and one or more footswitches. In this embodiment, there are two footswitches 14a, 14b. However, the number of footswitches is not important; there can be any number of footswitches in different embodiments of the invention.

Typically, the footswitches are configured to cause adjustments in an adjustable bed, such as a hospital bed, to which the footswitch assembly 10 is coupled. For example, in the depicted embodiment, footswitch 14a can be configured to be an “up” switch to raise the bed, and footswitch 14b can be configured to be a “down” switch to lower the bed.

For clarity of description, embodiments are described below on the basis of the base 12 being at the bottom of the footswitch assembly, for example by being placed upon a floor. However, the footswitch assembly can be placed in other orientations.

Each footswitch 14a, 14b is mounted on the base 12. Each footswitch 14a, 14b has an operative surface, respectively 15a, 15b, which is typically an upper surface. The footswitches are configured so that pressure of a foot on the operative surface 15a, 15b actuates the footswitch 14a, 14b.

Coupled to the base 12 is a guard member 16. The purpose of the guard member 16 is to prevent the footswitches 14a, 14b from being inadvertently actuated. The guard member 16 is movable between a guarding position, in which actuation of the footswitches 14a. 14b is inhibited, and a non-guarding position, in which actuation of the footswitches 14a, 14b is allowed. FIGS. 1 and 3 show the guard member 16 in the guarding position, and FIG. 2 shows the guard member in the non-guarding position.

In the embodiment depicted, the guard member 16 is a cover which, in the guarding position, substantially covers the footswitches 14a, 14b, in this case by overlying substantially the entirety of the operative surfaces 15a, 15b of the footswitches 14a, 14b.

The footswitch assembly includes a movement limiting element for preventing the guard member from moving closer to the operative surfaces 15a, 15b of the footswitches than when it is in the guarding position. The movement limiting element can for example be a shoulder on the guard member which abuts against the base 12 in the guarding position to prevent further movement towards the footswitches.

However, in other embodiments of the invention, the guard member can in the guarding position overlie only a part of the operative surfaces 15a, 15b of the footswitches 14a, 14b, for example the guard member 16 can be a bar. In other embodiments, the guard member 16 can in the guarding position, in combination with the base 12, substantially surround the footswitches 14a, 14b on all sides, or on all but one sides.

However, in all embodiments, the guard member 16 is arranged to at least inhibit and preferably prevent inadvertent actuation of the footswitches 14a, 14b by preventing for example a falling object or a foot heading towards an operative surface 15a, 15b from reaching that operative surface in such a way as to actuate the footswitch.

In the depicted embodiment, the guard member 16 is coupled to the base by a hinge 18. The hinge 18 allows the guard member 16 to pivot between the guarding position and the non-guarding position. However, the skilled person will appreciate that there are other means of allowing the guard member 16 to move between the guarding position and the non-guarding position.

The guard member 16 is biased towards the guarding position, for example by a resilient element in the hinge 18, so that in the absence of a user's foot, the guard member will move into the guarding position.

In the guarding position, there is an access region 20 between a lip 22 of the guard member 16 and the base 12. The lip 22 is at an end of the guard member 16 which is distal from the hinge 18. The access region 20 is insufficient to allow a user to insert their foot between the guard member and the footswitches 14a, 14b enough to actuate the footswitches, but allows a user to place an extremity of their foot, such as a toe area of their shoe, against the lip 22 to allow them to push the guard member 16 from the guarding position to the non-guarding position.

In the depicted embodiment, the extremity of the user's foot can be inserted between the footswitches 14a, 14b and the guard member 16 in order to move the guard member 16 into the non-guarding position. As shown in FIG. 1, in this embodiment the guard member is disposed at an angle with respect to the base in the guarding position. The angle is selected so that in the vicinity of the lip 22, there is sufficient space between the operative surfaces 15a, 15b and the guard member 16 to allow an extremity of a user's foot to be placed adjacent the lip 22 but insufficient space between the guard member 16 and the operative surfaces 15a, 15b to allow a user's foot to be inserted enough to actuate the footswitches. In other embodiments, a similar effect can be achieved by appropriate selection of the distance between the guard member and the operative surfaces in the guarding position. This effect can be achieved even when the guard member is parallel to the base 12 owing to the increasing thickness of a foot away from the toe area.

However, in other embodiments, the guard member is disposed in the guarding position to prevent a user from inserting any part of their foot between the operative surfaces and the guard member. In such embodiments, the guard member 16 can extend beyond an edge of the operative surfaces 15a, 15b of the footswitches 14a, 14b such that the user can place the extremity of their toot adjacent to the footswitches and against the lip 22, but not against the operative surfaces of the footswitches, to allow the user to move the guard member from the guarding position to the non-guarding position.

In embodiments in which the guard member in combination with the base surrounds the footswitches on all sides, the lip 22 can be provided in the form of a shoulder on an outer side of the guard member 16 against which the user can abut the extremity of their foot in order to move the guard member 16 from the guarding position to the non-guarding position.

The assembly 10 further includes a validation element 24. The validation element 24 includes a validation element switch 26 and a shoulder 28 which is configured to cause actuation of the validation element switch 26 upon movement of the guard member 16 from the guarding position to the non-guarding position. The validation element switch can be an interlock switch. In the embodiment depicted, the shoulder 28 is provided on the guard member 16 on the other side of the pivot 18 from the lip 22, and the validation element switch 26 is located in the base 12 on the other side of the hinge 18 from the footswitches 14a, 14b. In this way, as the lip 22 is raised, the shoulder 28 is lowered onto the validation element switch causing actuation of the validation element switch. However, in other embodiments in which the guard member is moved other than by pivoting, an appropriate configuration be apparent to the skilled person for causing the validation element switch to be actuated upon movement of the guard member from the guarding position to the non-guarding position. Furthermore, the locations of the validation element switch and the shoulder 28 can be interchanged.

In response to movement of the guard member into the non-guarding position, the validation element 24 is configured to validate subsequent actuations of the footswitches 14a, 14b.

In embodiments, the validation element can be coupled to a control mechanism of the bed, and the validation element can be configured to receive actuation signals, such as electrical signals, from the footswitches 14a, 14b in response to actuation of the footswitches 14a, 14b. Validating an actuation can include sending a signal to the control mechanism of the bed corresponding to an actuation signal received from a footswitch. If an actuation is not to be validated, then in response to receiving an actuation signal from a footswitch, the validation element can be configured not to send a corresponding signal to the control mechanism of the bed. In this way, the control mechanism of the bed can cause adjustments of the bed in response only to validated actuations of the footswitches.

However, upon the guard member 16 returning to the guarding position, the validation element switch 26 is released, and the validation element 24 is configured no longer to validate actuation of the footswitches 14a, 14b when the guard member 16 is in the guarding position.

In the preferred embodiment of the invention, the validation element 24 is configured to validate actuations of the footswitches 14a, 14b which occur within a pre-determined period of time subsequent to the movement of the guard member 16 into the non-guarding position. This provides a safety feature in the event of the guard member 16 unintentionally becoming jammed in the non-guarding position.

The assembly is operated in the following way. When the bed is not being operated, the footswitch assembly 10 is in the guarding position such as depicted in FIG. 1 and FIG. 3. In this position, if a user falls onto the footswitch assembly 10, or drops an object onto the footswitch assembly 10, the guard member 16 prevents that patient or that object from causing actuation of the footswitches 14a, 14b. Even if the patient or the user does cause actuation of the footswitches 14a, 14b, these actuations are not validated by the validation element 24, and accordingly the bed is not adjusted in response.

When a user, such as a nurse, wishes to adjust the bed, the user places their toe against the lip 22 of the guard member 16 and places an upward force against the lip 22, thereby moving the guard member 16 from the guarding position to the non-guarding position.

As shown in FIG. 2, as the guard member 16 moves into the non-guarding position, the shoulder 28 causes actuation of the validation element switch 26. Actuation of the validation element switch 26 starts a timer during which actuations of the footswitches 14a, 14b are validated. During this time, the user can use their foot to put pressure on the operative surfaces 15a, 15b of the footswitches 14a, 14b in order to cause adjustment of the bed.

After the predetermined period of time, actuations are no longer validated, and further actuation of the footswitches 14a, 14b do not cause adjustment of the bed.

In addition, after the user removes his or her foot from the assembly, the guard member 16 returns to the guarding position under the influence of the bias of hinge 18.

As can be seen from the above, the footswitch assembly described herein provides two layers of safety, by inhibiting inadvertent actuations of footswitches, and by not validating actuations of footswitches which may be unintended.

The resulting footswitch assembly takes up a small amount of space, which is advantageous where a space is at a premium for example below hospital beds which may need to be lowered to a very low position. In addition, the double safety feature described herein can be operated by a healthcare professional without needing to potentially contaminate his or her hands or gloves by touching a patient's bed or control unit with his or her hands.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

1. A footswitch assembly for controlling an adjustable bed, including:
a footswitch for controlling an adjustable bed, the footswitch having an operative element and being configured to be actuated in response to pressure of a foot or part of a foot upon the operative element;
a guard member movable between a guarding position and a non-guarding position;
wherein in the guarding position the guard member is configured to overlie a portion of the operative element to inhibit actuation of the footswitch, and wherein in the non-guarding position the guard member is configured to allow access to the operative element for actuation of the footswitch; and
a validation element configured in response to movement of the guard member into the non-guarding position to validate actuation of the footswitch.

2. A footswitch assembly according to claim 1, wherein the validation element is configured to validate actuation of the footswitch only during a predetermined period of time following a movement of the guard member into the non-guarding position.

3. A footswitch assembly according to claim 1, wherein the validation element is configured not to validate actuation of the footswitch when the guard member is in the guarding position.

4. A footswitch assembly according to claim 1, wherein the validation element includes a validation element switch which is actuated in response to movement of the guard member into the non-guarding position.

5. A footswitch assembly according to claim 1, wherein the guard member is configured to be movable from the guarding position to the non-guarding position by an extremity of a foot.

6. A footswitch assembly according to claim 1, wherein in the guarding position, the guard member is separated from the operative element of the footswitch to allow an extremity of a foot to be inserted between the operative element of the footswitch and the guard member to allow a user to move the guard member to the non-guarding position.

7. A footswitch assembly according to claim 6, wherein the operative element is an operative surface of the footswitch, and wherein in the guarding position the guard member is disposed at an angle with respect to the operative surface, said angle being selected so that there is sufficient space between the operative surface and the guard member for an extremity of a user's foot to move the guard member but insufficient space between the operative surface and the guard member to allow a users foot to be inserted enough to actuate the footswitch.

8. A footswitch assembly according to claim 1, wherein, in the guarding position, the guard member extends beyond an edge of the operative element of the footswitch to allow a foot of a user to contact the guard member in a region adjacent to the edge of the footswitch to allow a user to move the guard member to the non-guarding position.

9. A footswitch assembly according to claim 1, wherein the footswitch is mounted on a base and the guard member is hingedly coupled to the base.

10. A footswitch assembly according to claim 1, wherein the guard member includes a cover that covers the footswitch in the guarding position.

11. A footswitch assembly according to claim 1 wherein the footswitch includes a plurality of footswitches, each of the plurality of footswitches being for causing a different adjustment in an adjustable bed.

12. A footswitch panel including a plurality of footswitch assemblies according to claim 1.

13. An adjustable bed including a footswitch assembly of a footswitch panel according to claim 1, wherein the bed is configured to adjust in response to a validated actuation of the footswitch.

14-16. (canceled)

17. A footswitch assembly for controlling an adjustable bed, including:
footswitch for controlling an adjustable bed, the footswitch comprising an operative element configured to be actuated in response to applied pressure to the operative element;
a guard means movable between a guarding position and a non-guarding position;
wherein in the guarding position the guard means is configured to overlie a portion of the operative element to inhibit actuation of the footswitch, and wherein in the non-guarding position the guard means is configured to allow access to the operative element for actuation of the footswitch; and
a validation switch responsive to movement of the guard into the non-guarding position to validate actuation of the footswitch.

18. A footswitch assembly for controlling an adjustable bed, including:
a footswitch for controlling an adjustable bed, the footswitch comprising an operative element configured to be actuated in response to applied pressure to the operative element;
a guard movable between a guarding position and a non-guarding position;
wherein in the guarding position the guard is configured to overlie a portion of the operative element to inhibit actuation of the footswitch, and wherein in the non-guarding position the guard is configured to allow access to the operative element for actuation of the footswitch; and
a validation switch responsive to movement of the guard into the non-guarding position to validate actuation of the footswitch.
